(19) United States
(12) Patent Application Publication
(10) Pub. No.: US 2005/0177555 A1
(43) Pub. Date: Aug. 11, 2005

(54) System and method for providing information on a set of search returned documents

(76) Inventors: Sherman Robert Alpert, Briarcliff Manor, NY (US); Yurdaer Nezihi Doganata, Chestnut Ridge, NY (US); Lev Kozakov, Stamford, CT (US); John George Vergo, Yorktown Heights, NY (US); Catherine G. Wolf, Katonah, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/776,734

(22) Filed: Feb. 11, 2004

(51) Int. Cl. G06F 17/30

(52) U.S. Cl. 707/3

(57) ABSTRACT

A system and method for organizing document search results include identifying words having an association with search query terms. Features of the words are categorized in relation to the search query terms. The results of the document search are presented in at least one category in accordance with the features.

### BACKGROUND OF THE INVENTION

1. Field of the Invention

The present invention relates to searching digital information, and more particularly to providing additional information about documents retrieved in a search.

2. Description of the Related Art

When users search a large database of documents, such as for a technical support website, they may get hundreds of documents in the results list. Two challenges for designers of search systems are to convey the essence of each document, or relevant portion of the documents, and also the characteristics that distinguish one document from another. The second challenge has received little attention from researchers. It is also necessary to convey the needed information about the documents with a minimum number of words. Otherwise, the task of reading through the summaries of documents may be overwhelming.

Some typical ways of presenting the results of a search are: to display a human-crafted or automatically generated summary that is independent of the search terms entered by the user (the search terms are used to determine which documents are retrieved, but not the summary), to display a snippet of text from the document containing the search terms (as done, for example, on the GOOGLE™ search Web site), to display summaries of either of the above type categorized according to a pre-existing taxonomy (as done, for example, by the DELL™ site's search facility) or taxonomy generated on the fly (see, for example, the VIVISIMO™ site, http://www.vivisimo.com/; see also U.S. Pat. No. 5,924,090). The results of the search may be presented as text or a visualization (see. e.g., U.S. Pat. No. 6,434,556).

As text search becomes ubiquitous, users are more often facing a problem of finding relevant information in a heap of returned search results. Search engines offer several methods that help users to find relevant results without opening the documents. One of the most widely used methods is displaying summaries of the documents on the search results page. Another useful method is grouping or clustering search results based on some similarities between the documents.

One approach to building the content of the page summaries that appears in search results lists is known as “terms highlighted in context” or THIC. This page-summary method is used by some of the major World Wide Web search sites. In creating a THIC summary, snippets of text that include the user's search terms are found in a Web page and these snippets are combined to form the overall summary (Lawrence, S. & Giles, C. L. (1998). Context and Page Analysis for Improved Web Search, IEEE Internet Computing, 2(4), 38-46). The search terms found in the text are highlighted (typically by bolding) in the displayed summary.

In greater detail, each document summary in the results list includes one or more text snippets, each illustrating an instance of the use of one or more search terms in the Web page or document. In the simplest case, each snippet includes a contiguous chunk of text from the document in which a particular search term is shown along with surrounding text, that is, a fragment of text before the search term, the search term, and a fragment of text after the term. For example, the search terms “java” and “text” might result in snippets, such as: “A primary design goal of Java™ is to allow developers to write software that can . . . ” and “ . . . documentation regarding writing a text editor application in . . . ”. An example implementation of THIC may begin by finding the first occurrence of each search term in the document, and then, for each such occurrence, extracting a text snippet (of length of, say, 155 characters) showing the term in context. Then, overlapping snippets could be merged, thereby illustrating snippets wherein more than one search term occurs.

Hence, if the first snippet, including “Java”, overlaps with the first snippet including the word “text”, the two snippets can be merged into one (with additional processes to minimize the length of the resultant snippet).

Merging can be performed recursively on all resultant snippets (which becomes more important when there are more than two search terms). Care should be taken so that at the “edges” (the head and tail) of each snippet, words are not truncated. In general, in THIC summaries, ellipses appear between contiguous snippets; also if the front of the first snippet and similarly, if the tail of the last snippet is not the end of a sentence, ellipses are appended to its tail.

The following is an example of a THIC summary for the search terms “program database source”
. . . Great Development Environment that allows you to program in a . . . Sign up for the new Source Code Group today! . . . Browse the largest code database on the best site.

Different search engines use various THIC algorithms to select the document content snippets in proximity to the query terms, but all of them suffer from one common deficiency. This deficiency is that there is no guarantee that selected content snippets really help to distinguish one document from another in the retrieved set of documents. This is particularly a problem when a large number of documents are retrieved for a search.

A concept of clustering search results to help users navigating through the heap of returned documents exists in literature and has been implemented in several search engines, for example JURU™ (D. Carmel, E. Amitay, M. Herscovici, Y. Maarek, Y. Petruschka & A. Soffer, “Juru at TREC 10—Experiments with Index Pruning”, In Proceedings of NIST TREC (Text Retrieval Conference) 10, November 2001). The concept is to find similarities between returned documents in the vector space model, and use Hierarchical Agglomerative Clustering methods (G. Salton, M. McGill, Introduction to Modern Information Retrieval, Computer Series, McGraw-Hill, NY, 1983) to group returned documents in nodes of tree-like common terms for the cluster, or assign documents based on the predefined vocabulary/ontology.

The main deficiencies of existing search-results clustering-methods include some of the following:
a) Existing clustering methods take into account the whole set of each document's terms to determine similarities between documents in the vector space model; thus, two documents may be found similar even if the query terms in these documents appear in completely different contexts;
b) Existing clustering methods assign node labels based on the most common terms for the cluster, or on the predefined vocabulary/ontology; thus, the node labels may not be associated with the document context in proximity to the query terms. Because node labels may not capture important contextual information related to the query terms, such node labels may not be useful to users in determining the relevancy of documents.

Therefore, a need exists for a system and method for improving the result information conveyed after a document search. A further need exists for identifying the relevance of each document relative to the query used to discover the document.

### SUMMARY OF THE INVENTION

A system and method for organizing document search results include identifying words having an association with search query terms. Features of the words are categorized in relation to the search query terms. The results of the document search are presented in at least one category in accordance with the features.

These and other objects, features and advantages of the present invention will become apparent from the following detailed description of illustrative embodiments thereof, which is to be read in connection with the accompanying drawings.

### BRIEF DESCRIPTION OF DRAWINGS

The invention will be described in detail in the following description of preferred embodiments with reference to the following figures wherein:

FIG. 1 is a block/flow diagram for a system/method for organizing document search results in accordance with one embodiment of the present invention;

FIG. 2 is a block/flow diagram for the system/method of FIG. 1 illustratively showing an example of operation in accordance with one embodiment of the present invention;

FIG. 3 is an example document illustratively identifying search terms and document terms in accordance with one embodiment of the present invention;

FIG. 4 is a flow diagram showing a method for organizing/presenting documents search results in accordance with one embodiment of the present invention;

FIG. 5 is a table format presenting document summaries, category terms and document terms for documents uncovered by a search in accordance with one embodiment of the present invention;

FIG. 6 is another table format organized by category terms with numbers for corresponding documents in accordance with another embodiment of the present invention;

FIG. 7 is an outline format used for sorting documents by category in accordance with another embodiment of the present invention; and

FIG. 8 is a scatterplot showing categories on the respective axes with different symbols or colors to indicate additional categories in accordance with another embodiment of the present invention.

### DETAILED DESCRIPTION OF PREFERRED EMBODIMENTS

The present invention is directed to managing search results, and more particularly to providing systems and methods to allow search users to more readily deal with the search results, and for presenting/organizing the results in a more efficient way. The present invention focuses on document context in proximity with query terms for a document search, and labels and/or clusters returned results based on common features. Thus, the present invention provides users with labeling and/or clustering information that is tuned to the user's search terms, and, thus, more reliable information regarding the relevancy of the search results.

One innovation provided by the present invention includes the use of words in proximity to the user's search terms as the basis for document features and the extraction of dimensions that characterize the set of documents based on these features. As such, embodiments of the present invention use both information in the set of documents retrieved and the user's search terms to provide a view of the distinguishing characteristics of documents in the document set that is tailored to the search terms. The advantage of this approach includes the notion that the information used as the basis of dimensions describing the documents in the set of retrieved documents is taken from text in the documents in proximity to the user's search terms, and therefore is more likely to be relevant to the user's needs.

The present invention addresses the problem of distinguishing documents from each other, which are returned as the result of a search. An analysis step analyzes the features that describe the set of documents. This step may use all or part of the document. Because the relationship of the user's search terms to the features that characterize the set of documents is one important association, the analysis step uses words in proximity to the search terms as the basis for identification of features. The features that are selected to characterize the document may include context specific keywords, word associations or any other features, which may relate to the query terms or to aspects of the document. In addition, the analysis step may use key words and phrases stored with the document.

An extraction step uses the identified features to extract dimensions that describe the set of documents in relation to the user's search terms. This step may use factor analysis or a similar method to extract dimensions.

Distinguishing dimension information may be presented as a separate view on or in the results. It may be presented graphically with the documents represented as points in a space labeled with the dimensions. A pre-existing taxonomy may be used to label the dimensions where possible. For example, for a computer support database, LINUX® might be listed under “operating system” in the taxonomy. When the taxonomy cannot be used, the dimensions may be labeled with the features. The user may select a document to see its summary. For example, the document may be highlighted in the graphical representation and can be clicked on to open the document, web page, etc. The distinguishing information may also be displayed in a tabular format, or the documents may be grouped by distinguishing dimensions, or the dimensions may be shown with the summary.

It should be understood that the elements shown in FIGS. may be implemented in various forms of hardware, software or combinations thereof. Preferably, these elements are implemented in a combination of hardware and software on one or more appropriately programmed general-purpose digital computers having a processor and memory and input/output interfaces.

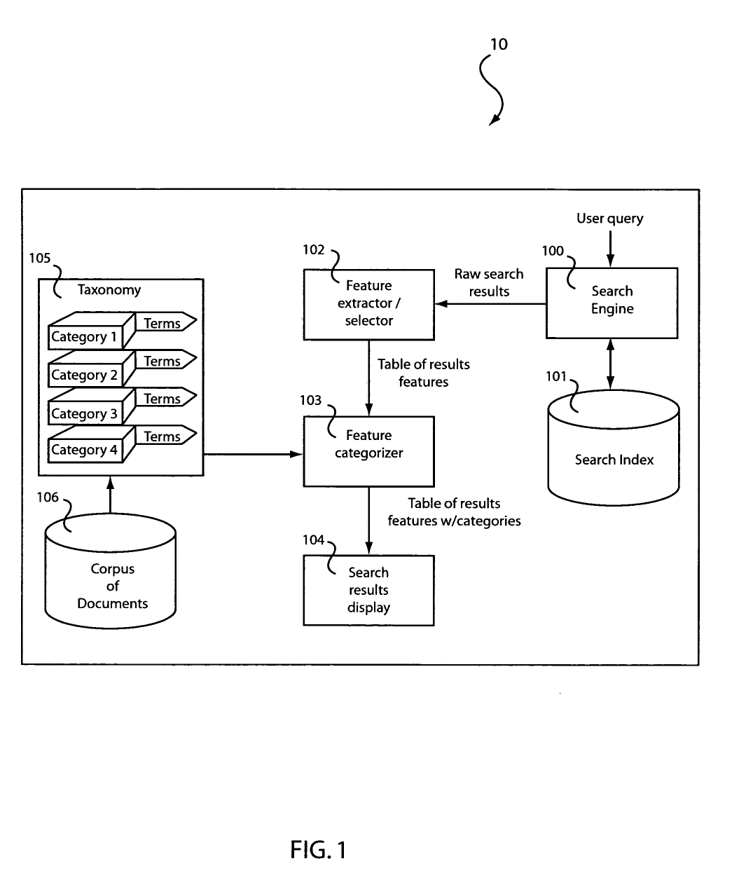

Referring now to the drawings in which like numerals represent the same or similar elements and initially to FIG. 1, an illustrative system/method 10 is depicted in accordance with one embodiment of the present invention. A user sends a search query to search engine 100, which, in turn, looks into a search index 101, and returns search results. Then, the raw search results are passed to a feature extractor/selector 102, which extracts/selects salient features from the documents, presented in the search results. In one example, the features include word distance of documents terms in proximity to the query terms. The search terms (tokens) and categories or other identifiers may be employed to better understand the context of the document. Features may include contexts of words or phrases in the document and the extractor may look for terms within a defined word distance from the respective matched token, or one or more terms within a defined logical distance from the respective matched token. The logical distance may include related sentence locators or other related information locators. The proximity (word distance) may be variable and based on user selection, search context, etc.

A feature categorizer 103 categorizes the selected features, using taxonomy categories 105 created based on a corpus of documents 106. Categorized features are passed to a search results display module 104, which displays enhanced search results with categorized features to the user. The taxonomy categories 105 may be predefined or may be generated based on the corpus of documents (e.g., common subjects and sub-subjects, etc.).

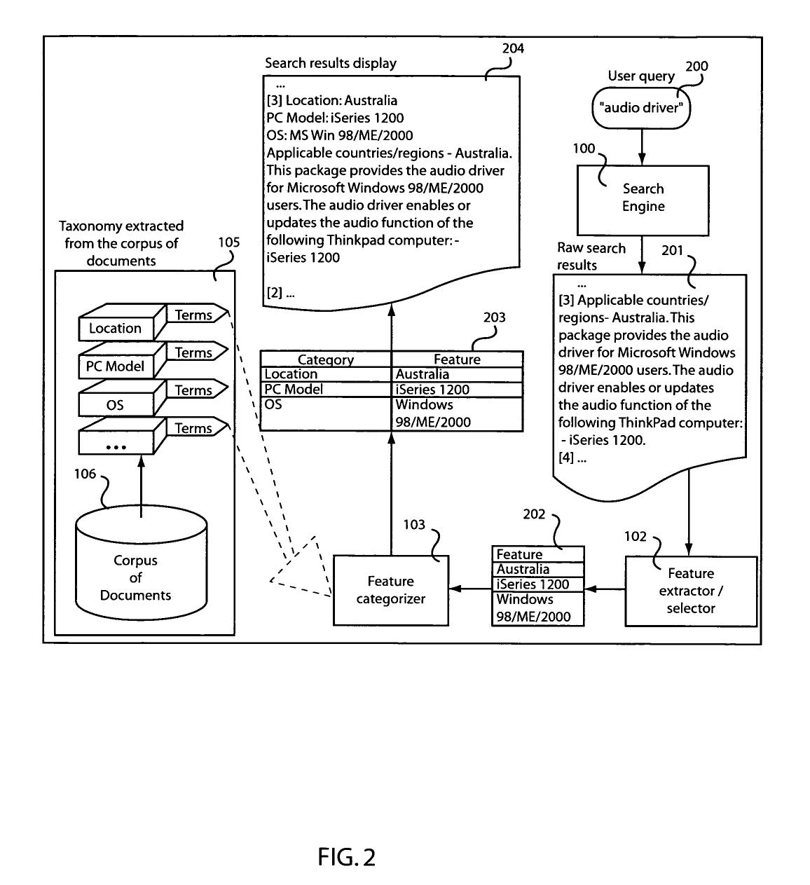

Referring to FIG. 2, the processing of a sample search query will now be illustratively described. Block 200 shows a sample query that is submitted to search engine 100. This query may be submitted by a user of a search service by typing or otherwise entering keywords or other symbols or graphics. For example, if the user enters the search terms “audio, driver” to search engine 100, snippets of text including the search terms from a plurality of documents are returned as raw search results 201.

Block 201 illustratively shows a fragment of the search results received from the search engine 100 with keys words highlighted. The raw search results are then processed by feature extractor/selector 102. In this way, the presence of predetermined features is determined or is selected within each document. Table 202 shows a fragment of the table of features, created by the feature extractor/selector 102 for document #3.

In this example, the following illustrative features are extracted from each document in accordance with the taxonomy of the system: location, PC model and operating system (OS). Table 203 shows a fragment of the table of categorized features, created by the feature categorizer 103, based on taxonomy categories 105 for a single illustrative document #3. These include features are the location (Australia), PC Model (iSeries 1200™) and operating system (Windows™ 98/ME/2000). Other features and categories are also contemplated and may be selected based on the query topics and based on user preferences.

Block 204 shows a fragment of the enhanced search results display with categorized features. Other formats and arrangements of this data are contemplated. The search results display 204 merely illustrates one way in which to display the results.

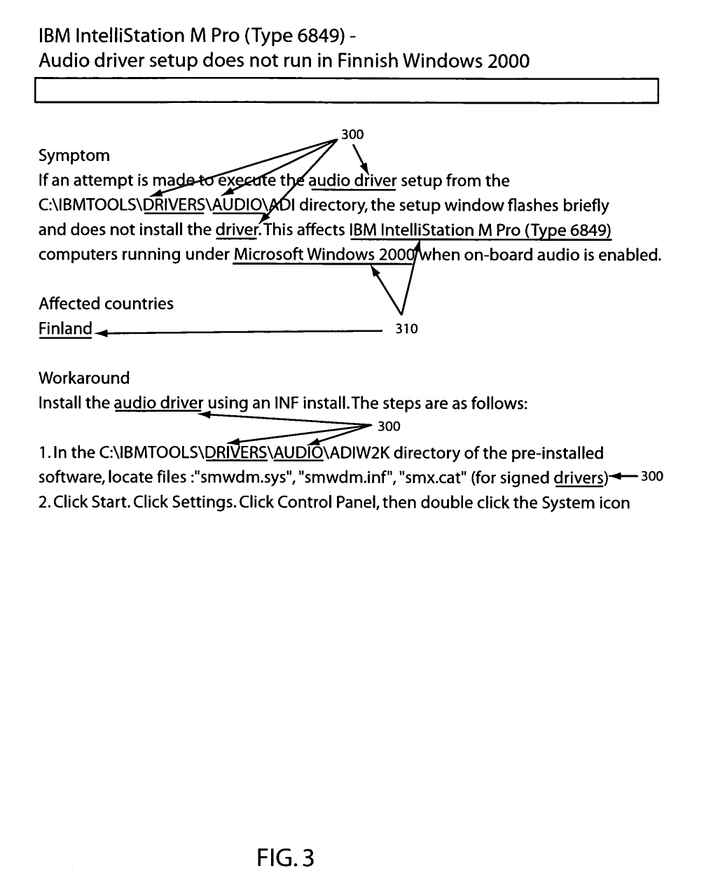

Referring to FIG. 3, a sample document fragment with highlighted search terms 300 (query terms) and document terms 310 is illustratively shown. This example assumes the user entered a search query of “windows audio drivers” thus specifying a search for documents that include those terms or words. The document in FIG. 3 matches the search criteria. The words labeled 300 (and also underlined) are search query terms found in the document. Terms labeled 310 (and underlined) are document terms found in proximity to the search terms found in the document. These document terms are determined based on the query terms and the taxonomy 105 (FIG. 1).

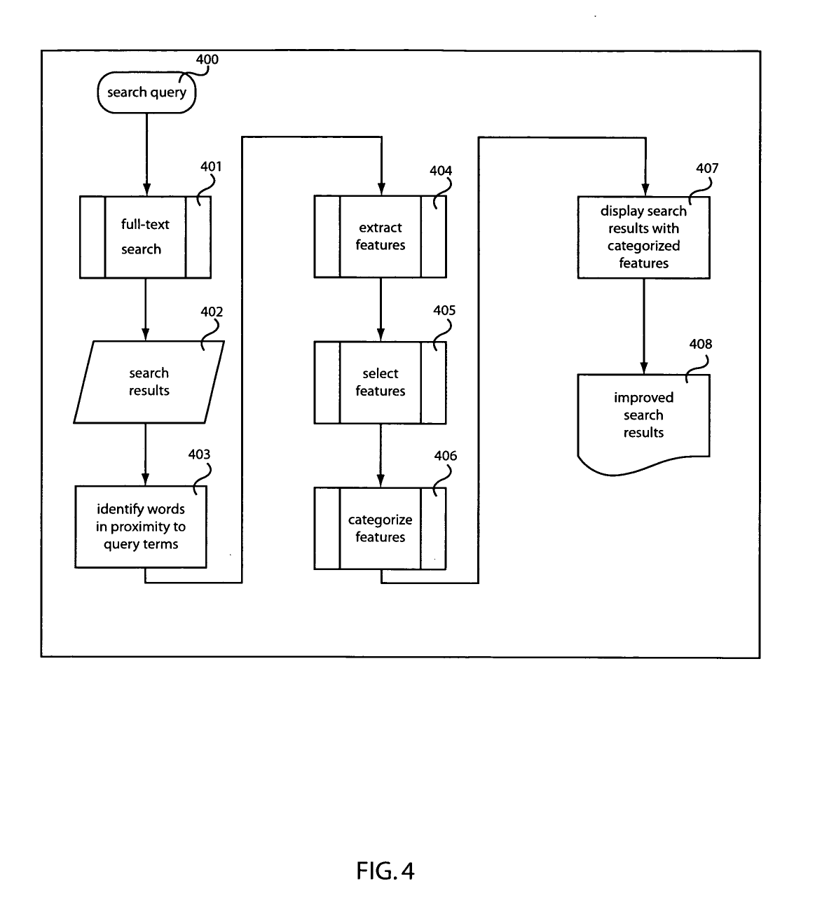

Referring to FIG. 4, processing flow in a system of one embodiment of the present invention is illustratively shown. A search query 400 is processed by a search engine that performs a full text search operation 401, and generates search results 402. Then, the search results are processed by a feature extractor/selector that performs identification of words (terms) in proximity to the query terms in block 403, extracts features in block 404, and selects features in block 405. The feature extraction process in 404 may be implemented based on prior art as disclosed in Doganata, Kozakov, Fin, and Drissi (2003), which teaches how to select the salient keywords for a specific context in a document (Doganata, Y., Kozakov, L., Fin, T. H. Drissi, Y., (2003), Extracting Salient Keywords In a Document That Belongs To a Specific Context For an Autonomic Response, IBM Technical Disclosure Bulletin, Jan. 3, 2003), incorporated herein by reference. Then, the table of selected features is processed by a feature categorizer, which performs categorization of the features in block 406, and passes the table of categorized features to the display results module, which displays search results with categorized features in block 407, creating enhanced search results in block 408.

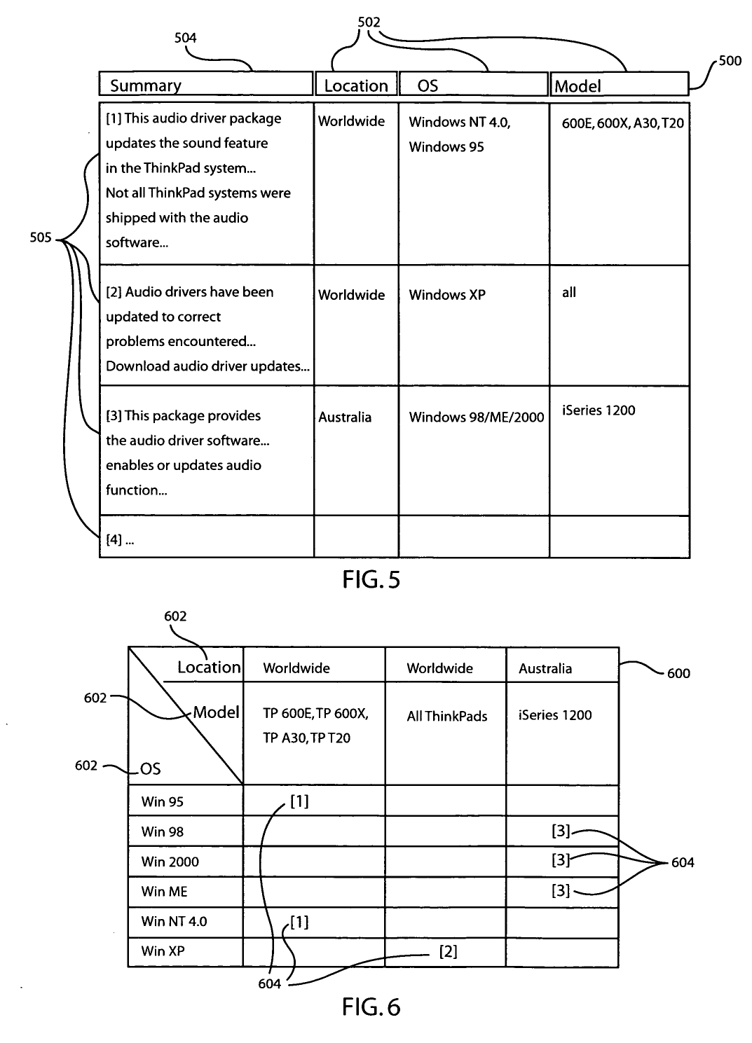

The examples shown in FIGS. 5 through 8 are all possible presentations of results, which illustrate some of the inventive features of the present invention. FIGS. 5 through 8 portray examples of different presentations, displaying document summaries along with each document's distinguishing category information of users.

Referring to FIG. 5, the category terms illustratively selected for the system include “Location,” “OS” (for Operating System), and “ThinkPad module.” FIG. 5 displays information for documents in the form of a table 500. Columns 502 of the table represent 3 category terms and a document summary 504. Each row 505 of the table (labeled 1-4) represents a single document retrieved as a result of the search, that is, each row is a document. The category term columns 502, labeled “Location,” “OS,” and “ThinkPad model,” include the specific document terms corresponding to each category.

Referring to FIG. 6, documents in the search results list are portrayed in this embodiment as a table 600. Here, the table 600 is organized around three dimensions 602 representing the 3 category terms “Location,” “Model,” and “OS.” Numbers 604 in cells of the table represent specific documents in the search results list. For example, the “[1]” in the upper left data cell represents document number 1 in the results list. In the example table, the document #1 is applicable to Models “TP 600E, TP 600×, TP A30, TP T20” and its applicable geographic Location is “Worldwide.” Users can click on a number in a data cell to view the corresponding document's summary (or the document itself, depending on the implementation).

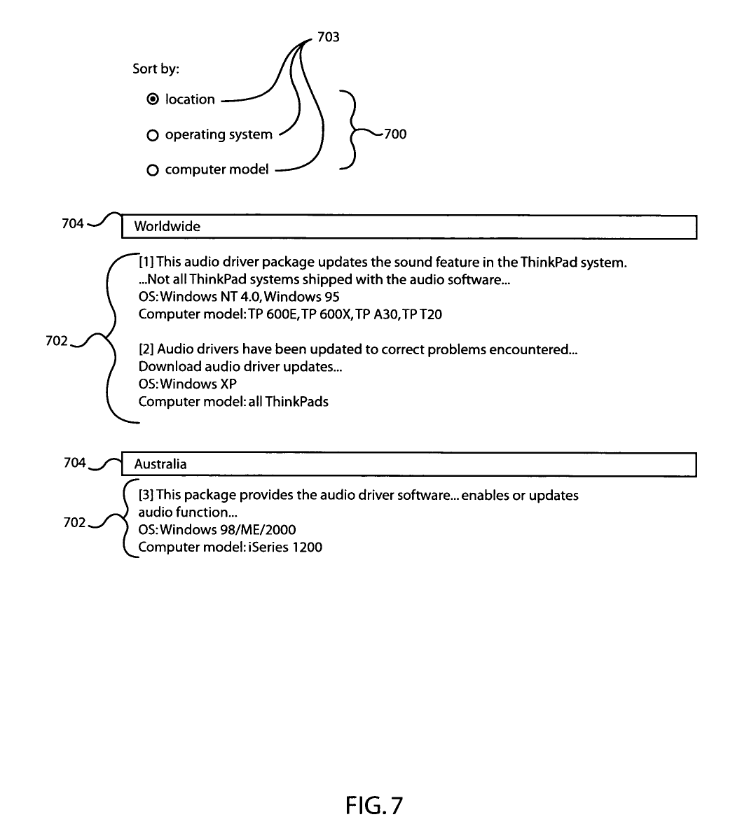

Referring to FIG. 7, in this embodiment, each document in the search results appears in a sorted or categorized or clustered list. The user has the option on how he or she wishes the list to be sorted. The sorting options are based on the category terms found in the set of documents. A sorting option 700 may be selected by the user directly or be a default setting. In this case, the categories include “location,” “operating system,” and “computer model.” When one of these options is selected by the user, with option select 700, a list of summaries 702 appears with documents clustered according to the selected category 703. In the example show in FIG. 7, the documents in the results list are clustered by “location.” There is a heading 704 for each location found in the documents in the results list. For example, under the heading “Worldwide” appear all documents that are applicable worldwide, that is, all documents whose document term for the “location” category term is “Worldwide.” When a user selects a different category term to sort the documents by (e.g., “operating system” or “computer model”), the documents are re-sorted and re-displayed. For each document in the list, this example presentation shows the document summary and its document terms for the categories other than the one that has been selected for sorting the documents. Other options and configurations are also contemplated.

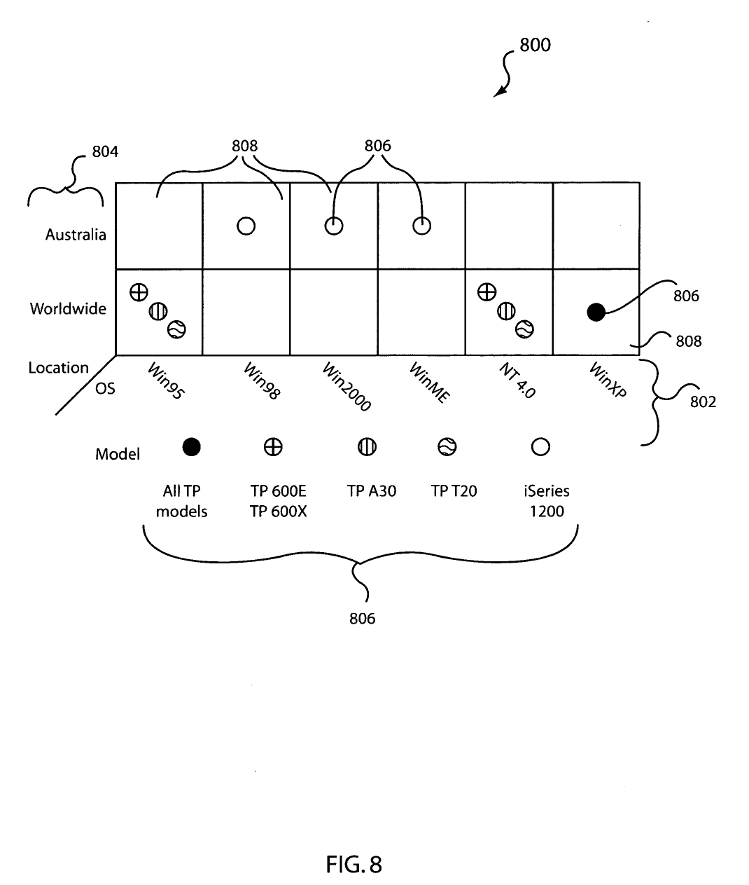

Referring to FIG. 8, a graphical “scatterplot” tabular format 800 is illustratively shown in accordance with yet another embodiment. The graph's x-axis, in region 802, represents the “OS” (operating system) category term and is labeled with the specific document terms found among the documents in the search results list for the “OS” category term. The y-axis, in region 804, represents the “Location” category term and is labeled with the specific document terms found among the documents in the search results list for this category. Circles or other indicators 806 in data cells 808 represent documents with document terms matching the intersecting category terms. A third dimension, representing the “Model” category term, is represented by a different colored, shaped or types of symbols. Each circle or symbol may be unique to a type of entity in that category. Users can click on a circle to view the corresponding document's summary (or the document itself, depending on implementation).

Having described preferred embodiments of a system and method for providing information on a set of search returned documents (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A method for organizing document search results comprising the steps of:
identifying words having an association with search query terms;
categorizing features of the words in relation to the search query terms; and
presenting the results in at least one category in accordance with the features.

2. The method as recited in claim 1, wherein the association between words and search query terms includes proximity between the words and the search query terms in a document.

3. The method as recited in claim 1, wherein the step of categorizing features includes the step of extracting features from a document based on the association between the words and the search query terms.

4. The method as recited in claim 4, further comprising the step of selecting features from extracted features based upon a subject matter of the search query terms.

5. The method as recited in claim 1, wherein the step of presenting includes presenting the results in a table in accordance with the at least one category.

6. The method as recited in claim 1, further comprising the step of providing a sort option to permit the results to be sorted and presented in accordance with one or more categories.

7. The method as recited in claim 1, wherein the step of presenting includes presenting the results in a plot.

8. A program storage device readable by machine, tangibly embodying a program of instructions executable by the machine to perform method steps for organizing document search results as recited in claim 1.

9. A method for presenting search results, comprising the steps of:
searching one or more documents in a corpus of documents, to retrieve documents as a result a query term matching with a matched token in one or more of the documents;
selecting at least one document term in a set of the document terms, the document terms being in proximity to the matched token;
categorizing the selected document terms into at least one category;
describing the categories using one or more category terms; and
presenting a hit list of the documents with the one or more category terms associated with each of the documents.

10. The method as recited in claim 9, wherein the step of selecting includes selecting document terms, which include one, or more terms within a defined word distance from the respective matched token.

11. The method as recited in claim 9, wherein the step of selecting includes selecting one or more terms within a defined logical distance from the respective matched token.

12. The method as recited in claim 11, wherein the logical distance includes related sentence locators.

13. The method as recited in claim 9, wherein the proximity is variable based one of user selection and search context.

14. The method as recited in claim 9, wherein the step of categorizing includes clustering document terms.

15. The method as recited in claim 9, wherein the step of categorizing includes using pre-defined category terms.

16. The method as recited in claim 15, wherein the pre-defined categories are in category ontology.

17. A program storage device readable by machine, tangibly embodying a program of instructions executable by the machine to perform method steps for presenting search results as recited in claim 9.

18. A document search presentation system, comprising:
a feature extractor, which extracts and selects features within documents provided in accordance with a search query;
a feature categorizer coupled to the feature extractor, the feature categorizer associating the features in the documents to categories in accordance with taxonomy categories; and
a format, which presents at least a portion of the documents in association with a category of the taxonomy categories.

19. The system as recited in claim 18, wherein the format includes at least one of a table and a plot.

20. The system as recited in claim 18, wherein the format includes snippets associated with search terms and/or features.

21. The system as recited in claim 18, wherein the features include a word distance between document search terms matched tokens in the document.

22. The system as recited in claim 21, wherein the word distinct includes a defined logical distance from the matched token to the document search term.
